(19) United States
(12) Patent Application Publication
(10) Pub. No.: US 2016/0034669 A1
(43) Pub. Date: Feb. 4, 2016

(54) METHOD, SYSTEM AND APPARATUS FOR CONTROLLING DISPENSING OF MEDICATION

(71) Applicant: Kian MAHBUBIAN, Calgary (CA)

(72) Inventor: Kian MAHBUBIAN, Calgary (CA)

(21) Appl. No.: 14/810,571

(22) Filed: Jul. 28, 2015

Related U.S. Application Data
(60) Provisional application No. 62/031,241, filed on Jul. 31, 2014.

(51) Int. Cl. G06F 19/00; G05B 15/02

(52) U.S. Cl. CPC G06F 19/3462; G05B 15/02

(57) ABSTRACT

A method, system and apparatus for controlling dispensing of medication is provided. The system comprises: a device comprising: a sensor for detecting opening and closing of a dispenser; a memory storing a dispensing schedule; an alert device for providing alerts; a short range wireless communication interface; and a processor configured to: control the alert device to provide alerts according to the schedule; and communicate sensor data using the interface; and, a communication device comprising a processor, a memory storing a dispensing application, a short range wireless communication interface; and a long range communication interface, the processor configured to: receive the dispensing schedule using the application; and transmit the dispensing schedule to the device using the respective communication interface and the application, and transmit data associated with the application using the long range interface, the data comprising one or more of the schedule and the sensor data.

### FIELD

The specification relates generally to dispensing medication, and specifically to a method, system and apparatus for controlling dispensing of medication.

### BACKGROUND

Dispensing of medication can occur via “smart” pill bottles that provide an alert, such as a blinking light, once it is time to take a pill. Alerts can also be provided remotely using expensive techniques such as cell phone alerts, text messages and the like. Use of cell phone networks by the bottle generally leads to short battery life and large form factors in the bottle to accommodate the required hardware. Furthermore, programming of the smart pill bottle generally occurs via the cell phone network, and a service is charged for communicating with the smart pill bottle; charges for text messages can also be incurred. Alternatively, some pill cases rely on a cell phone being physically integrated with the case to provide alerts once it is time to take a pill.

### SUMMARY

In general, this disclosure is directed to a system that includes a device that monitors opening and closing of a dispenser, such as a pill bottle and the like, stores a dispensing schedule, and provides alerts according to the dispensing schedule; the device can further communicate wirelessly with a communication device using a short range wireless interface. The dispensing schedule can be set up using an application at the communication device, and the communication device can further provide alerts according to the dispensing schedule. When the opening and closing of the dispenser does not match the dispensing schedule, further alerts can be provided. Furthermore, the device and/or the communication device can provide interim alerts, for example reminders of when to take food and/or drink prior to an event in the dispensing schedule. The communication device can further communicate with a server, which can store data associated with the application at the communication device, and further communicate the sensor data and the like to the server. The server can send alerts to remote communication devices, which can be referred to as “angel” devices, according to the dispensing schedule and/or when the opening and closing of the dispenser does not match the dispensing schedule, so that users associated with the angel devices can contact a user who is using the dispenser, the device and the communication device to ensure they are following the dispensing schedule. In particular implementations, system can comprise a cap, and the like, for a pill bottle, which communicates with a smartphone, the cap and the smartphone communicating using short range interfaces, including, but not limited to, a Bluetooth™ Low Energy (“BLE”) interface.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” can be construed as X only, Y only, Z only, or any combination of two or more items X, Y, and Z (e.g., XYZ, XY, YZ, ZZ, and the like). Similar logic can be applied for two or more items in any occurrence of “at least one . . . ” and “one or more . . . ” language.

An aspect of the specification provides a system comprising:a device comprising: a sensor configured to detect opening and closing of a dispenser; a memory storing a dispensing schedule; an alert device configured to provide alerts; a short range wireless communication interface; and a processor configured to: control the alert device to provide alerts according to the dispensing schedule; and communicate sensor data using the short range wireless communication interface; and,a communication device comprising a respective processor, a respective memory storing a dispensing application, a respective short range wireless communication interface; and a long range communication interface, the respective processor configured to: receive the dispensing schedule using the dispensing application; and transmit the dispensing schedule to the device using the respective short range wireless communication interface and the dispensing application, and transmit data associated with the dispensing application using the long range communication interface, the data comprising one or more of the dispensing schedule and the sensor data.

The system can further comprise a server configured to: communicate with the communication device using the long range communications interface to receive and store the data associated with the dispensing application received from the communication device. The server can be further configured to transmit respective alerts to one or more remote computing devices according to one or more of the dispensing schedule and when the sensor data indicates that the opening and the closing of the dispenser is not occurring according to the dispensing schedule. The server can be further configured to transmit the data associated with the dispensing application to one or more remote computing devices so that the one or more remote computing devices can provide respective alerts according to one or more of the dispensing schedule and when the sensor data indicates that the opening and the closing of the dispenser is not occurring according to the dispensing schedule. The server can be further configured to transmit the associated with the dispensing application to a new communication device storing a respective dispensing application, the new communication device configured to communicate with the device.

The system can further comprise one or more remote computing devices, each comprising a respective application configured to provide respective alerts according to one or more of the dispensing schedule and when the sensor data indicates that the opening and the closing of the dispenser is not occurring according to the dispensing schedule. The respective alerts provided by the respective application at each of the one or more remote computing devices can be customizable using the respective application.

The processor can be further configured to transmit one or more of firmware updates and software updates to the device using the respective short range wireless interface.

The dispensing schedule can comprise one or more times that items stored at the dispenser are to be dispensed and one or more further times that one or more of food and drink are to be ingested, one or more of the device and the dispensing application further configured to provide respective alerts according to the one or more times and the one or more further times.

One or more the device and the dispensing application can be further configured to provide an alert when the device and the communication device lose communication with each other.

The communication device can be further configured to communicate with two or more devices, including the device, to provide respective dispensing schedules to each of the two or more devices, and provide respective alerts according to each of the respective dispensing schedules.

The device can be further configured to provide the alerts in an absence of connectivity between the device and the communication device, and after the dispensing schedule is received at the device.

### BRIEF DESCRIPTIONS OF THE DRAWINGS

For a better understanding of the various implementations described herein and to show more clearly how they may be carried into effect, reference will now be made, by way of example only, to the accompanying drawings in which:

FIG. 1 depicts a schematic diagram of a system for controlling dispensing of medication, according to non-limiting implementations.

FIG. 2 depicts a schematic block diagram of a device used in the system of FIG. 1, the device configured to provide alerts for taking medication and track opening and closing events at a sensor, according to non-limiting implementations.

FIG. 3 depicts a schematic block diagram of a communication device used in the system of FIG. 1, the device configured to provide a dispensing schedule and connectivity to the device of FIG. 2, according to non-limiting implementations.

FIG. 4 depicts the system of FIG. 1, in which the communication device of FIG. 3 provisions the device of FIG. 1 with a dispensing schedule, according to non-limiting implementations.

FIG. 5 depicts the system of FIG. 1, in which alerts of when to take medications are provided at various devices, according to non-limiting implementations.

FIG. 6 depicts the system of FIG. 1, in which interim alerts are provided at various devices, according to non-limiting implementations.

FIG. 7 depicts the system of FIG. 1, in which alerts that a dispensing schedule is not being followed is provided at various devices, according to non-limiting implementations.

FIG. 8 depicts the system of FIG. 1, in which alerts of when to take specific medications are provided at various devices, according to non-limiting implementations.

FIG. 9 depicts the system of FIG. 1, in which alerts of when to take medications from specific dispensers are provided at various devices, according to non-limiting implementations.

### DETAILED DESCRIPTION

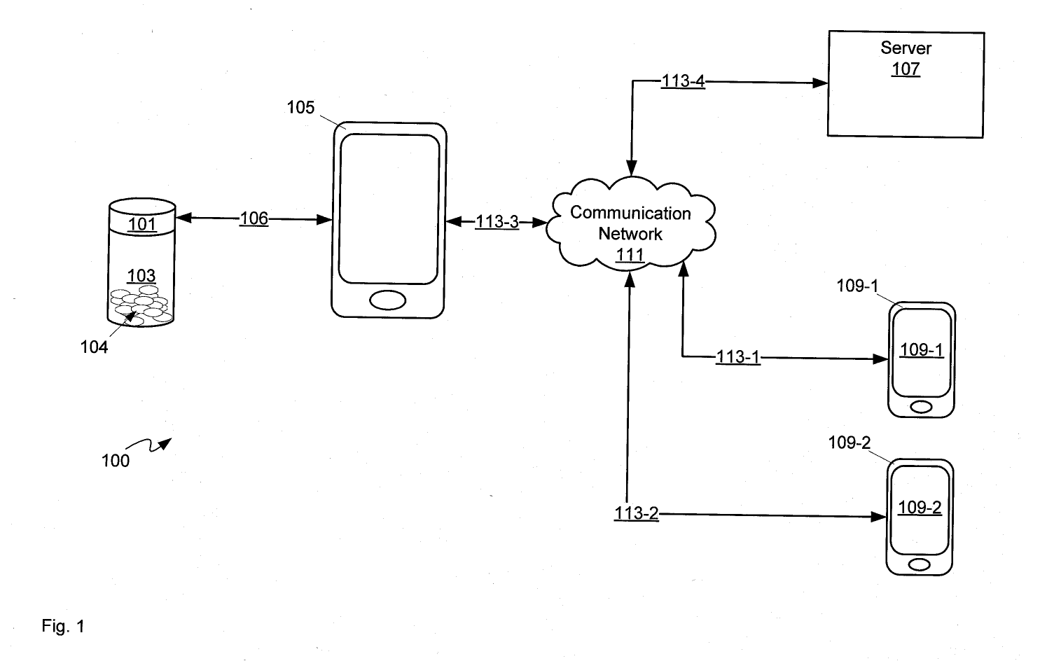

FIG. 1 depicts a system 100 for controlling dispensing of medication comprising: a device 101 configured for detecting opening and closing of a dispenser 103, the dispenser 103 configured to store medication 104; a communication device 105 in communication with device 101 using a short range link 106; a server 107; optional remote communication devices 109-1, 109-2 (collectively referred to as devices 109, and generically as a device 109); and a communication network 111, server 107 in communication with devices 105, 109 using network 111 and links 113-1, 113-2, 113-3, 113-4 (collectively referred to as links 113, and generically as a link 113). While system 100 is depicted with two devices 109, devices 109 are optional and hence, in some implementations, system 100 can comprise no devices 109, but system 100 can comprise one device 109, or more than two devices 109.

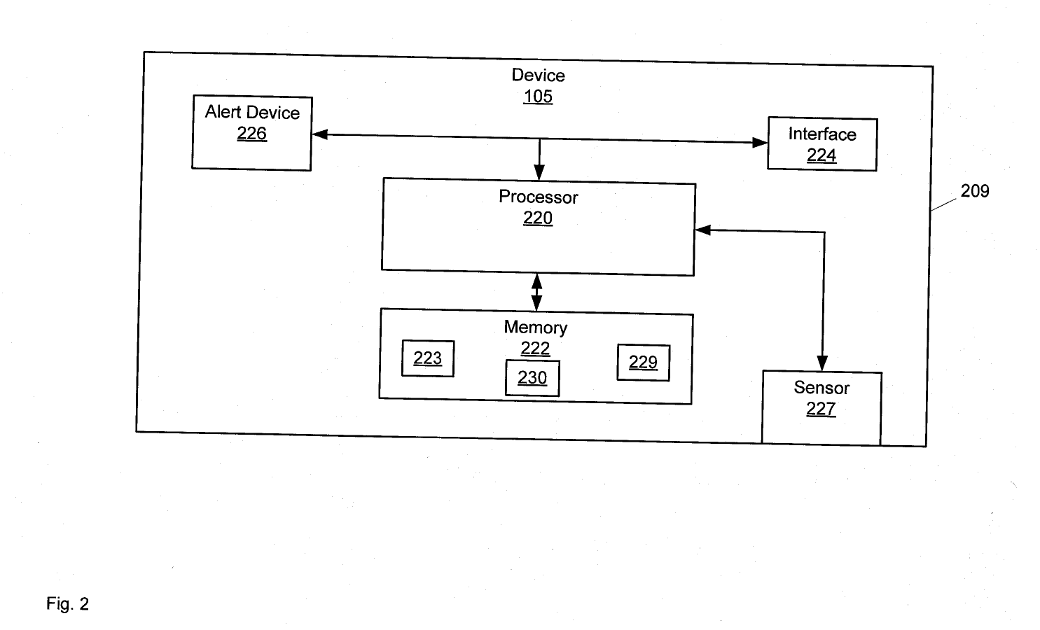

In general, device 101 comprises a sensor (for example see FIG. 2) configured to monitor opening and closing of dispenser 103, and provide alerts for when medications 104 are to be taken, including, but not limited to, visual, aural, haptic, textual, and graphical alerts. As depicted, device 101 comprises a cap, and dispenser 103 comprises a pill bottle, hence device 101 (i.e. the cap) is configured to mate with and removabley seal dispenser 103 (i.e. the pill bottle), and medication 104 can include, but is not limited to pills, liquids, supplements, vitamins, prescribed medication, and the like. As will be described in more detail below, device 101 stores a dispensing schedule (referred to hereafter as a schedule) as to when medication 104 is to be taken by a user of device 101 and device 105, and device 101 further senses when dispenser 103 is opened and closed: each opening and closing event is assumed to be associated with the user removing medication from dispenser 103 and taking medication 104. Hence, the opening and closing events can be compared to the schedule to determine whether medication 104 is being taken according to the schedule.

Devices 101, 105 communicate using link 106, and device 105 can be used to upload a dispensing schedule to device 101 so that that device 101 can determine when to provide alerts; furthermore, device 101 can transmit sensor data indicative of the openings and closings to device 105, which can compare the sensor data to the schedule to determine whether the schedule is being followed.

Device 101 can transmit the schedule and the sensor data to server 107 using appropriate links 113 and network 111, and server 107 can also track whether the schedule is being followed.

In some implementations, server 107 can transmit alerts to one or more devices 109 so that one or more of devices 109 can provide respective alerts according to one or more of the dispensing schedule and when the sensor data indicates that the opening and the closing of dispenser 103 is not occurring according to the dispensing schedule. Hence, devices 109 can be colloquially referred to as “angel” devices as users associated with devices 109 can call a user of devices 101, 105 when it is time to take medication 104 and/or when the schedule is not being followed. For example, when a user of devices 101, 105 is elderly, mentally incapacitated, and the like, an “angel” (for example a relative, a friend and the like) can assist the user with taking medication 104 and/or monitor when medication 104 is being taken and/or monitor whether medication 104 is missed.

In particular non-limiting implementations, device 105 comprises an application (which can colloquially referred as an “app”) which, when processed by a processor of device 105 causes device 105 to communicate with device 101 and server 107, receive the schedule for example from an input device and the like, provide alerts, transmit the schedule to device 101, receive firmware and/or software from server 107, transmit firmware and/or software to device 101, provide alerts when devices 101, 105 are separated and/or lose communication and the like.

Each of devices 109 comprises a respective application (which can also colloquially referred as an “app”) which, when processed by a respective processor of a device 109 causes device 109 to communicate with server 107, receive the schedule and/or alerts from server 107, provide alerts and the like. Indeed, as alerts can be received as application data from server 107, rather than as text messages and/or cell phone messages, charges for such can be avoided.

Attention is next directed to FIG. 2 which depicts a schematic diagram of device 101, device 101 comprising a housing 209, a processor 220 interconnected with a memory 222 storing a dispensing schedule 223, a communication interface 224, an alert device 226, and a sensor 227.

In some implementations, housing 209 can be generally enabled to mate with dispenser 103 and removabley seal dispenser 103. For example, housing 209 can comprise a pill bottle cap configured to mate with a pill bottle; however, in other implementations, housing 209 can comprise a bag for containing medication, and/or any other suitable device for enclosing and/or dispensing medication. In other words, in these implementations, dispenser 103 can be integrated with housing 209 and/or device 101.

Processing unit 220 comprises any suitable processor, or combination of processors, including but not limited to a microprocessor, a central processing unit (CPU) and the like. Other suitable processing units are within the scope of present implementations.

Memory 222 can comprise any suitable memory device, including but not limited to any suitable one of, or combination of, volatile memory, non-volatile memory, random access memory (RAM), read-only memory (ROM). Other suitable memory devices are within the scope of present implementations. In particular, memory 222 is enabled to store dispensing schedule 223 and sensor data, as will be described below.

Communication interface 224 comprises any suitable communication interface, or combination of communication interfaces for wirelessly communicating with device 105 using link 106. Accordingly, interface 224 is enabled to communicate according to any suitable protocol which is compatible with link 106, including but not limited to wireless protocols, cell-phone protocols, wireless data protocols, WiFi protocols, WiMax protocols and/or a combination, or the like. In particular non-limiting implementations, however, interface 224 is enabled to communicate with device 105 using any suitable combination of short range protocols, NFC (near field communication) protocols, Bluetooth™ protocols, or the like. For example, interface 224 can comprise a short range communication interface that can communicate with device 105 using a suitable short range protocol including, but not limited to Bluetooth Low Energy (BLE) protocol.

Alert device 226 can comprise any combination of visual, aural, haptic, textual, and graphical alert devices including, but not limited to one or more of: a light, and LED (light emitting device), a speaker, a vibration motor, and a display (e.g. a liquid crystal display (LCD) and the like). Alert device 226 can provide one or more visual, aural, haptic, textual, and graphical alerts at times according to dispensing schedule 223.

In other words, dispensing schedule 223, which can be received from device 105, comprises times at which medication 104 is to be taken, and processor 220 can process schedule 223 and control alert device 226 to provide an alert at times that medication 104 is to be taken. As such, it is assumed in the present specification that device 101 also comprises a clock device which can include, but is not limited to, a clock device of processor 220.

Sensor 227 comprises a sensor for detecting opening and closing of dispenser 103, and can include, but is not limited to a small switch that is depressed when device 101 is mated with dispenser 103 (i.e. dispenser 103 is closed) and released when device 101 is not mated with dispenser 103 (i.e. dispenser 103 is opened). Processor 220 can detect a state of sensor 227 and store such sensor events as sensor data 229.

Memory 222 can also store firmware 230 which, when processed by processor 220 causes processor 220 to implement the above described functionality of device 101. Those skilled in the art will now recognize that memory 222 is an example of computer readable media that can store programming instructions executable on processor 220 which can include firmware 230. Furthermore, memory 222 is also an example of a memory unit and/or memory module. Furthermore, memory 222 storing firmware 230 is an example of a computer program product, comprising a non-transitory computer usable medium having a computer readable program code adapted to be executed to implement one or more methods, for example one or more methods stored in firmware 230.

While not depicted, device 101 further comprises a power source, for example a connection to a battery, a power pack and the like and/or a connection to a main power supply and a power adaptor (e.g. and AC-to-DC (alternating current to direct current) adaptor, and the like), which can be used to power device 101 and/or charge a battery and the like. Housing 209 can be configured to be opened to replace a battery and the like.

In any event, it should be understood that a wide variety of configurations for computing device 101 are contemplated.

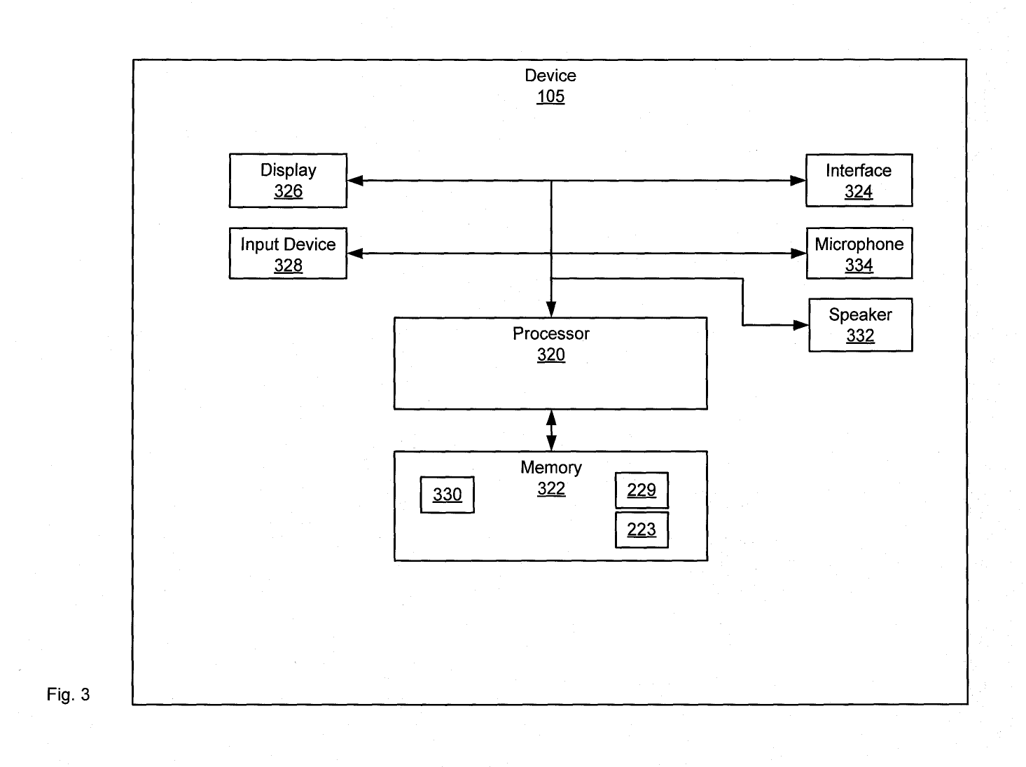

Attention is next directed to FIG. 3, which depicts a schematic diagram of device 105, which can include, but is not limited to, any suitable combination of electronic devices, communications devices, computing devices, personal computers, servers, laptop computers, portable electronic devices, mobile computing devices, portable computing devices, tablet computing devices, laptop computing devices, internet-enabled appliances and the like. Other suitable devices are within the scope of present implementations. In particular non-limiting implementations, device 105 can comprise a smartphone.

Device 105 comprises a processor 320 interconnected with a memory 322, a communication interface 324, a display 326, an input device 328, an optionally a speaker 332 and a microphone 334.

Processor 320 can be implemented as a plurality of processors, including but not limited to one or more central processors (CPUs). Processor 320 is configured to communicate with memory 322 comprising a non-volatile storage unit (e.g. Erasable Electronic Programmable Read Only Memory (“EEPROM”), Flash Memory) and a volatile storage unit (e.g. random access memory (“RAM”)). Programming instructions that implement the functional teachings of computing device 110 as described herein are typically maintained, persistently, in memory 322 and used by processor 320 which makes appropriate utilization of volatile storage during the execution of such programming instructions. Those skilled in the art will now recognize that memory 322 is an example of computer readable media that can store programming instructions executable on processor 320. Furthermore, memory 322 is also an example of a memory unit and/or memory module.

Memory 322 further stores dispensing schedule 223, sensor data 229 received from device 101, and a dispensing application 330 that, when processed by processor 320, enables processor 320 to communicate with device 101 and server 107, and transmit dispensing schedule 223 to device 101 using a respective short range wireless communication interface of interface 324, and transmit data associated with dispensing application 330 using a long range communication interface of interface 324, the data comprising one or more of dispensing schedule 223 and sensor data 229. Processing of application 330 can optionally enable processor 320 to provide functionality of device 105. Furthermore, memory 322 storing application 330 is an example of a computer program product, comprising a non-transitory computer usable medium having a computer readable program code adapted to be executed to implement a method, for example a method stored in application 330.

Processor 320 also connects to interface 324, which can be implemented as one or more radios and/or connectors and/or network adaptors and/or transceivers, configured to communicate with device 101 and server 107 via one or more wired and/or wireless communication links there between. It will be appreciated that interface 324 is configured to correspond with communication architecture that is used to implement one or more communication links 106, 113 with device 101, network 111, and server 107, including but not limited to any suitable combination of, cables, serial cables, USB (universal serial bus) cables, and wireless links (including, but not limited to, WLAN (wireless local area network) links, WiFi links, WiMax links, cell-phone links, Bluetooth links, NFC (near field communication) links, packet based links, the Internet, analog networks, access points, and the like, and/or a combination).

In particular, interface 324 comprises: a respective short range wireless communication interface, including, but not limited to a BLE interface; and a long range communication interface, including, but not limited to a cell phone interface, and the like, for communicating with server 107.

Display 326 comprises any suitable one of, or combination of, flat panel displays (e.g. LCD (liquid crystal display), plasma displays, OLED (organic light emitting diode) displays, capacitive or resistive touchscreens, CRTs (cathode ray tubes) and the like). Speaker 332 comprises any suitable speaker for converting audio data to sound to provide one or more of audible alerts, audible communications from remote communication devices, and the like. Microphone 334 comprises any suitable microphone for receiving sound and converting to audio data. In some implementations, input device 328 and display 326 can be external to device 105, with processor 320 in communication with each of input device 328 and display 326 via a suitable connection and/or link.

At least one input device 328 is generally configured to receive input data, and can comprise any suitable combination of input devices, including but not limited to a keyboard, a keypad, a pointing device, a mouse, a track wheel, a trackball, a touchpad, a touch screen and the like. Other suitable input devices are within the scope of present implementations.

While not depicted, device 105 further comprises a power source, for example a connection to a mains power supply and a power adaptor (e.g. and AC-to-DC (alternating current to direct current) adaptor, and the like).

In any event, it should be understood that a wide variety of configurations for device 105 are contemplated.

Server 107 can comprise any suitable server that can communicate with devices 105, 109 and comprises a processor, a memory storing programming instructions executable on the processor of the server, and a communication interface configured to communicate with devices 105, 109 via links 113 and network 111. For example, server 107 can be based on any well-known server environment including a module that houses one or more central processing units, volatile memory (e.g. random access memory), persistent memory (e.g. hard disk devices) and network interfaces to allow server 107 to communicate over a link to communication network 111. For example, server 107 can comprise a Sun Fire V480 running a UNIX operating system, from Sun Microsystems, Inc. of Palo Alto Calif., and having four central processing units each operating at about nine-hundred megahertz and having about sixteen gigabytes of random access memory. However, it is to be emphasized that this particular server is merely exemplary, and a vast array of other types of computing environments for server 107 are contemplated. It is further more appreciated that server 107 can comprise any suitable number of servers that can perform different functionality of server implementations described herein, including, but not limited to, a firmware server, database server and an application server, and the like.

In particular, server 107 is configured to: communicate with device 105 using the long range communications interface of device 105 to receive and store data associated with dispensing application 330 received from device 105. For example, server 107 can also store dispensing schedule 223 and sensor data 229 be further configured to transmit respective alerts to one or more remote computing devices 109 according to one or more of dispensing schedule 223 and when sensor data 229 indicates that the opening and the closing of dispenser 103 is not occurring according to dispensing schedule 223.

In some implementations, in order to alleviate processing power from server 107, server 107 stores events that can then either be pulled by devices 109 and/or pushed to devices 109. For example, one or more of devices 109 can assess if a critical event has occurred (e.g. a pill has been missed, and/or communication between device 105 and server 107 has been severed, and the like), the assessment based on data received at a device 109 from server 107. Hence, assuming one or more devices 109 comprises a smartphone, and/or has processing power suitable for assessing critical events, such an implementation leverages the processing power of devices 109, to alleviate processing at server 107, for example, when server 107 is managing many devices 105 and/or many devices 109.

Each of devices 109 can be similar to device 105 and can comprise respective processors, memories and communication interfaces. In particular, each device 109 can comprise a respective application configured to provide respective alerts according to one or more of dispensing schedule 223 and when sensor data 229 indicates that the opening and the closing of dispenser 103 is not occurring according to dispensing schedule 223. In yet further implementations, device 105 can comprise a device 109; in other words, device 105 can be configured to act as an “Angel” device in addition to the functionality described above; such redundancy at device 105 can cause additional alerts (alerts being described below) to occur at device 105 to emphasize to a user of device 105 when to take medication 104, and the like.

It is further appreciated that devices 105, 109 be equipped with any well known operating system, and/or applications described herein can be provided within any well known operating system, including, but not limited to, Android™ operating systems, Apple™ operating systems, Unix™ operating systems, Linux™ operating systems, and the like.

In some implementations, server 107 can transmit dispensing schedule 223 and sensor data 229 to one or more of devices 109 so that a respective processor on one or more of devices 109 can have similar functionality as device 105; alternatively, one or more of devices 109 can provide alerts when received by server 107. Furthermore, respective alerts provided by a respective application at each of the one or more remote computing devices 109 can be customizable using the respective application; for example, the respective alerts can be provided as visual, audio and/or haptic alerts according to the customization using the respective application.

In particular, the alerts can be provided in conjunction with the respective applications and/or received as application data (e.g. in-app notifications) and not cell phone messages and/or text messages and the like and their associated costs. In other words, server 107 can transmit application data to one or more of devices 109 and the application data can be provided as an alert in association with the application at devices 109.

Network 111 can comprise any suitable combination of communication networks, including, but not limited to, wired networks, wireless networks, WLAN networks, WiFi networks, WiMax networks, cell-phone networks, Bluetooth networks, NFC (networks, packet based networks, the Internet, analog networks, access points, and the like, and/or a combination.

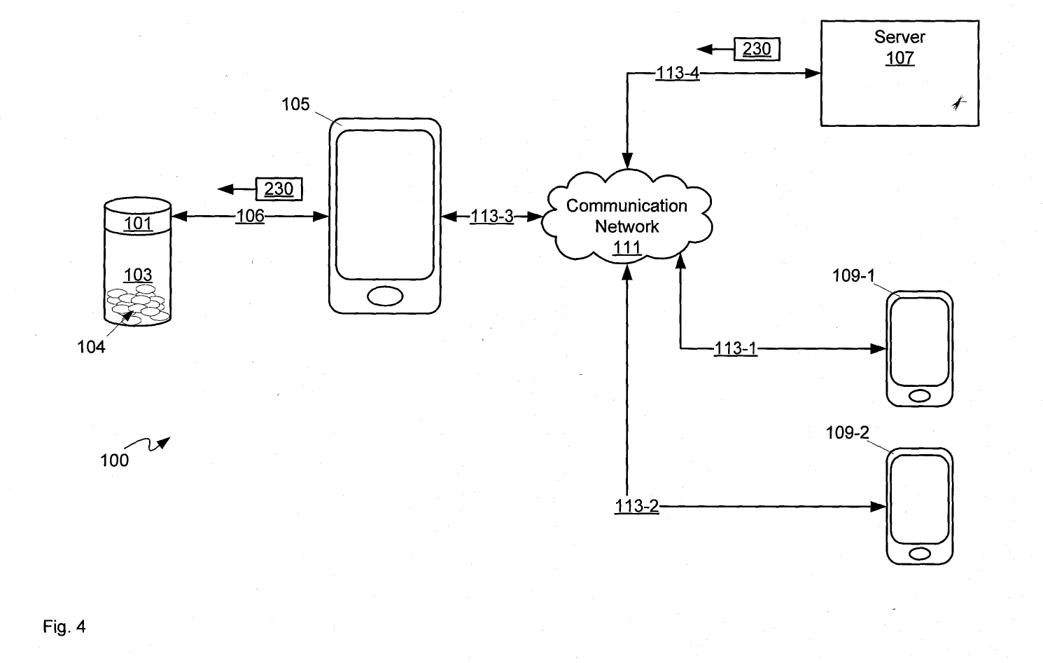

Various aspects of system 100 will next be described with reference to FIGS. 4-9, each of which are substantially similar to FIG. 1, with like elements having like numbers.

Attention is first directed to FIG. 4, where it is assumed that that device 105 has registered with server 107, and furthermore device 105 has registered a make, model and the like of device 101 with server 107. Specifically FIG. 4 depicts a process for one or more provisioning and updating firmware 230 for device 101. For example, server 107 can determine whether firmware and/or updates to firmware are available for device 101 and transmit firmware 230 to device 105 using links 113, and device 105 can in turn transmits firmware 230 to device 101 where processor 220 can install firmware 230. IN some implementations device 105 can query server 107 to see if newer firmware is available on server 107; if so, device 105 can request the firmware from server 107 and push the firmware to device 101. Hence, device 101 can have its firmware (and hardware using firmware 230) capabilities updated and upgraded, remotely and wirelessly. Hence, as wireless technologies evolve and improve (e.g. updates and improvements to BLE), device 101 can be updated accordingly.

Similarly, by updating firmware 230, functionality of device 101 can be updated.

While not depicted, server 107 can also transmit updates to application 330 to device 105 using links 113 so that functionality of device 105, as it relates to device 101, can be updated so that both functionality of device 101 and its software portals (e.g. application 330) can be updated without the need of buying a new product. Alternatively, device 105 can query server 107 to see if newer software is available on server 107 (and/or an mobile app-store) and request the newer software and/or updates itself therefrom.

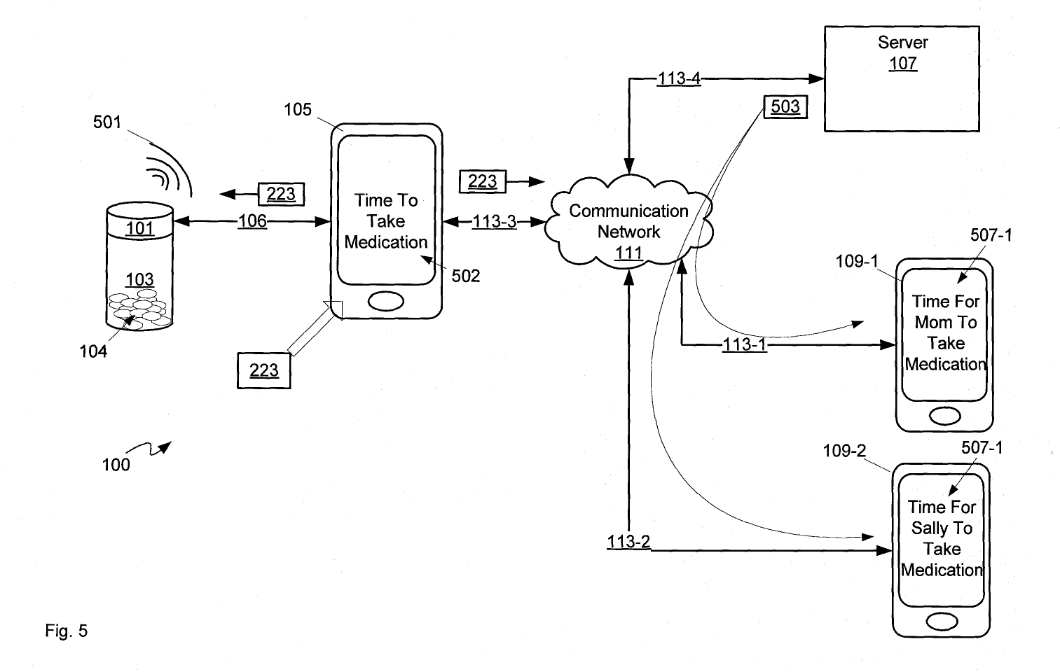

Attention is next directed to FIG. 5, where device 105 receives dispensing schedule 223 via an input device of device 105, for example, a touchpad, a keyboard, a virtual keyboard and the like, for example via a user interacting with input device 328 to enter schedule 223 into device 105. In some implementations, schedule 223 can be received via a camera at device 105 capturing a QR (quick response) code; in some implementations, the QR code can comprise schedule 223 while in other implementations, the QR code can be retrieved from an address embedded in the QR code. Either way, once device 105 has received schedule 223, schedule 223 can be transmitted to device 101 via short range link 106, where schedule 223 is processed by processor 220, which controls alert device 226 to provide an alert 501 at a time to take medication 104, including, but not limited to, a light, a blinking light, an audible alert, a vibration alert, a message at a display at device 101 and the like.

Furthermore, alert 501 can be provided in the absence of link 106; in other words, once schedule 223 is received at device 101, alert 501 can be provided regardless of whether device 101 is communicatively coupled to device 105 or not. Hence, device 101 can provide alerts 101 as a “standalone” device without the use of an extra router, or even device 105. In other words, device 101 can function independent of device 105 once schedule 223 is received, and alert 501 will occur according to schedule 223, with sensor 227 recording opening and closing events that are synchronized with device 105 when connection/link 106 is again established, as described below.

Hence, device 101 can be used without costly routers, hubs or constant connectivity (which can come with steep monthly fees).

Alternatively, device 105 can process schedule 223 and provide an alert 502 at a time to take medication 104 including, but not limited to, a light, a blinking light, an audible alert, a message at display 326 (as depicted) and the like.

As also depicted in FIG. 5, device 105 can transmit schedule 223 to server 107, which, in turn, can transmit an alert 503 to one or more of devices 109 at a time to take medication 104. Alternatively, server 107 can transmit schedule 223 to devices 109, after schedule 223 is received from server 107, and one or more of devices 109 can determine when to provide alerts to take medication 104. Either way, one or more of devices 109 can provide a respective alert 507-1, 507-2 indicating that medication 104 should be taken. As also depicted in FIG. 5, each alert 507-1, 507-2 can be customized; for example, a user of device 109-1 can be a child of a user of devices 101, 105, and hence alert 507-1 is customized to indicate that medication 104 is to be taken by a parent, while a user of device 109-2 can be a friend of a user of devices 101, 105, and hence alert 507-2 is customized to indicate that medication 104 is to be taken by a friend (“Sally”).

It is further appreciated that each of devices 109 can be provisioned within system 100 using application 330 at device 105. For example, application 330 can be controlled using a pull down menu, and the like, to prompt a user of device 105 can enter a network identifier of a device 109, such as a cell phone number and the like; the network identifier can be transmitted to server 107 using links 113, and server 107 can transmit a message to the device 109 associated with the network identifier to prompt a user of device 109 to download a respective “Angel” application through which alerts associated with device 101 can be provided, as describe below. Once the respective application is installed at device 109, alerts can be provided via the application. Furthermore, as devices 109 are provisioned using device 105, a user of device 105 can select which “Angels” they would like to use within system 100, for example a family member and/or friend.

Schedule 223 can comprise one or more times that items (e.g. medication 104) stored at dispenser 103 are to be dispensed and one or more further times that one or more of food and drink are to be ingested. Hence, one or more of device 101 and dispensing application 330 can be further configured to provide respective alerts according to the one or more times and the one or more further times.

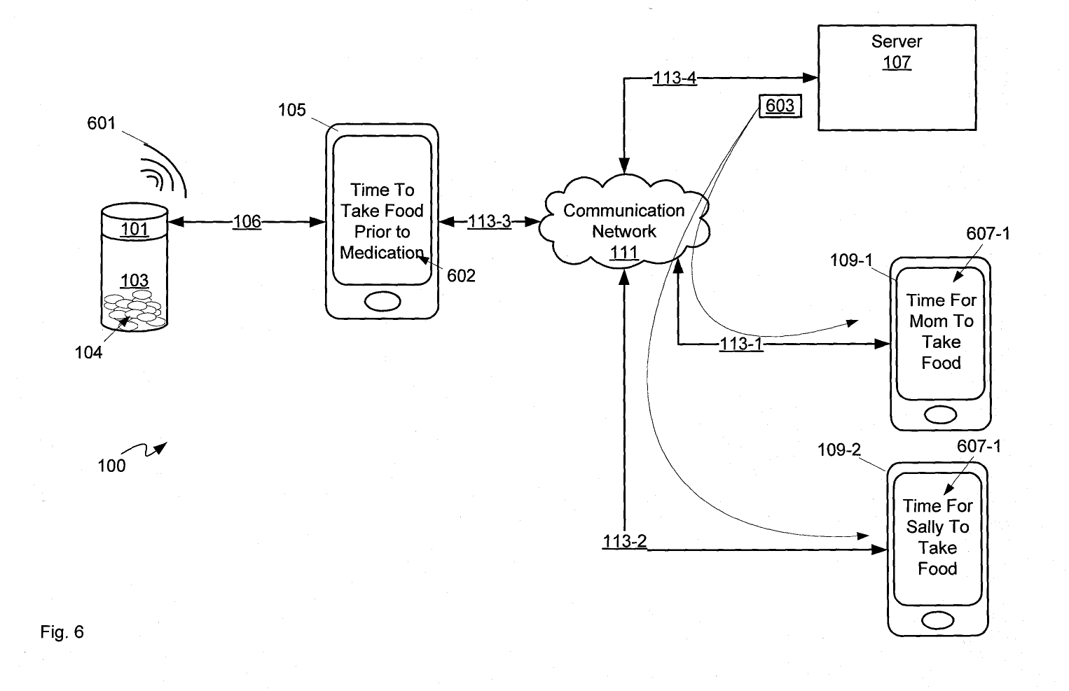

For example, attention is next directed to FIG. 6 which depicts device 101 providing alert 601 to take food and/or drink, alert 601 provided at time prior to a time for taking medication 104; alert 601 can be different from alert 501, for example a different colour, noise, vibration pattern and/or message. Similarly, device 105 is depicted as providing an alert 602 at a time to take food prior to taking medication 104. While optional, server 107 is depicted as transmitting an alert 603 to devices 109, which each provide a respective alert 607-1, 607-2 of a time to take food. Alternatively, as described above, server 107 can transmit schedule 223 to devices 109, after schedule 223 is received from server 107, and one or more of devices 109 can determine when to provide alerts 607-1, 607-2.

Device 101 can transmit sensor data 229 to device 105, for example, periodically, whenever devices, 101, 105 establish communications, whenever an opening and/or closing event is detected by sensor 227, whenever sensor data 229 is updated at device 101, and the like. Sensor data 229 can be received and processed at device 105 and compared with schedule 223. When sensor data 229 is indicative that an opening and closing event did not occur within a time period around a time to take medication 104 indicated by schedule 223, device 105 can provide an alert 702 that medication 104 was not taken. (i.e. alert 702 is provided when sensor data 229 indicates that the opening and the closing of dispenser 103 did not occur according to dispensing schedule 223).

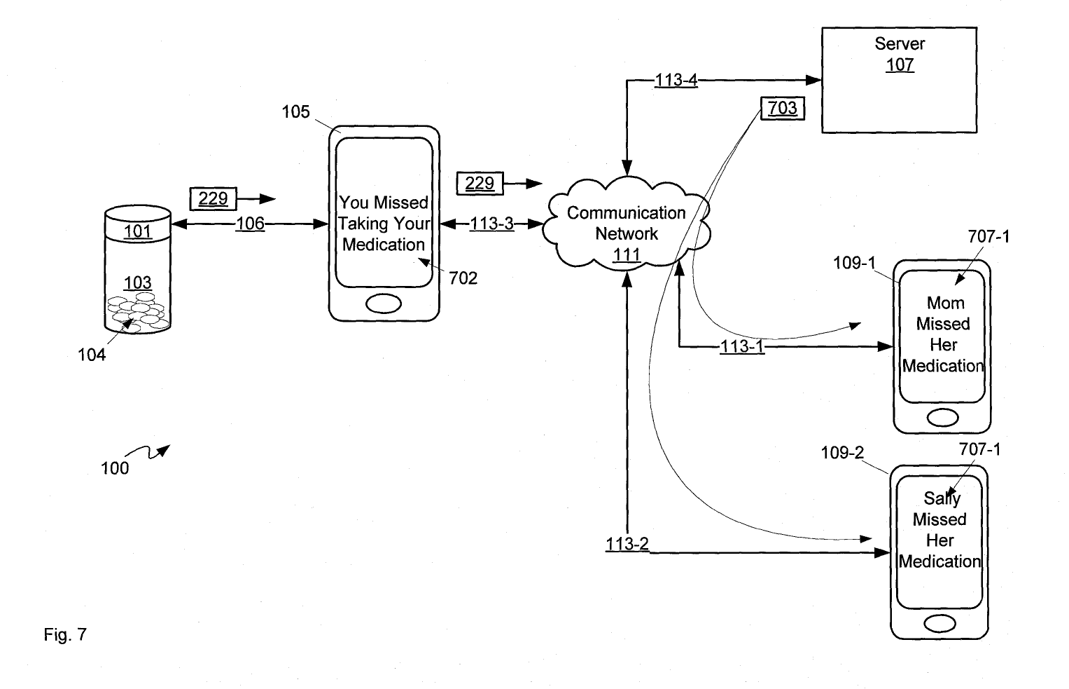

Alternatively, and as also depicted in FIG. 7, device 105 can transmit sensor data 229 to server 107, which can transmit an alert 703 to one or more of devices 109 when sensor data 229 indicates that the opening and the closing of dispenser 103 did not occur according to dispensing schedule 223; one or more of devices 109 can, in turn, provide a respective alert 707-1, 707-2 that medication 104 was not taken. Alerts 707-1, 707-2 can hence trigger users of devices 109 to contact a user of devices 101, 105 to prompt them to take medication 104. Alerts 707-1, 707-2 can be provided one or more of periodically, within a given time period after medication 104 is not taken, and the like. For example, alerts 707-1, 707-2 can be provided at the same time each day and/or within one to two hours after medication 104 is missed. When alerts 707-1, 707-2 are provided periodically, alerts 707-1, 707-2 can provide an indication of which medication was missed, when medication was missed, and the like.

In some implementations, applications at devices 109 can be customized to receive alerts and/or notifications at a given periodicity and/or time of day, for example once a day at the end of the day, and/or to provide reports on when medication 104 was taken or not rather than an alert. Such customization can further include, but is not limited to, customizing a type of alert (e.g. visual, aural, a loudness of an aural alert, etc.), customizing when alerts are provided, disabling alerts around vacation schedules, and the like. Similar customization can be provided for application 330 at device 105.

As described above, device 101 can function in the absence of connectivity with device 105 (i.e. absence of link 106) once schedule 223 is received at device 101; further, even in the absence of connectivity, device 101 continues to store sensor data 229. Once connectivity is re-established with device 105 (i.e. link 106 is re-established), synchronization can occur between devices 101, 105, with any updated to schedule 223 being transmitted to device 101 from device 105, and sensor data 229 being transmitted from device 101 to device 105; “Angel” alerts, such as alerts 701-1, 707-2 can be provided after such synchronization, when sensor data 229 is transmitted from device 105 to server 107. Hence, alerts 707-1, 707-2 can be delayed until synchronization between devices 101, 105 occurs.

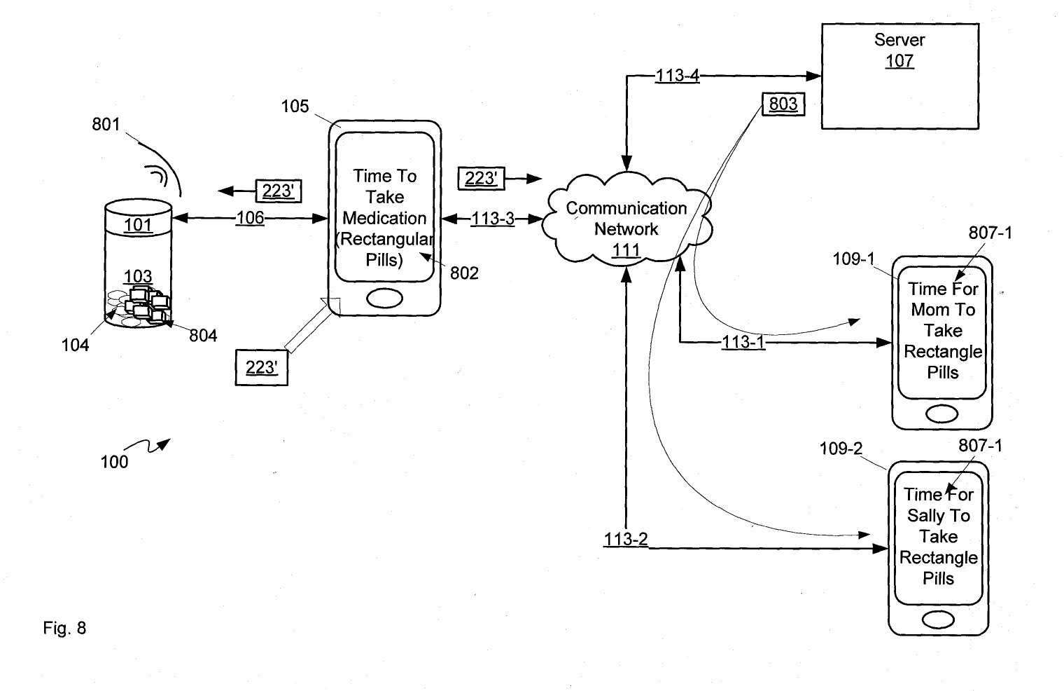

In yet further implementations, dispensing schedule 223 can be adapted for taking different types of medication. For example, attention is next directed to FIG. 8 in which dispenser 103 has been opened and medication 804 has been added to medication 104 (e.g. dispenser 103 stores two different medications in FIG. 8, which can be different shapes and/or sizes colours and/or have different markings, and the like). Schedule 223 can be updated to schedule 223′ using application 330, schedule 223′ comprising times at which each of medications 104, 804 are to be taken. Schedule 223′ is transmitted to device 101. Alert 801, different from alert 501, can hence be provided at device 101 at time for taking medication 804, while alert 501 can be provided at a time to, for taking medication 104, as depicted in FIG. 5; when the times are the same and/or similar, alerts 501, 801 can alternate. Each of alerts 501, 801 can hence be indicative of which medication 104, 804 to take; for example different colour alerts can be used and/or different aural alerts can be used, and the like; in some implementations, a colour of an alert 501, 801 can be similar to a colour of medication 104, 804, as indicated by schedule 223′. Furthermore, alert 802 can be provided at device 105, alert 802 indicative of which medication 104, 804 to take (e.g. rectangular pills (medication 804) instead of oval shaped pills (medication 104)).

Optionally, updated schedule 223′ can be transmitted to server 107, which can transmit an alert 803 to one or more devices 109, which can in turn provide respective alerts 807-1, 807-2 indicating a given one of medication 104, 804 to be taken, at a time that the given medication 104, 804 is to be taken. Alternatively, server 107 can transmit schedule 223′ to devices 109, after schedule 223′ is received from server 107, and one or more of devices 109 can determine when to provide alerts 807-1, 807-2.

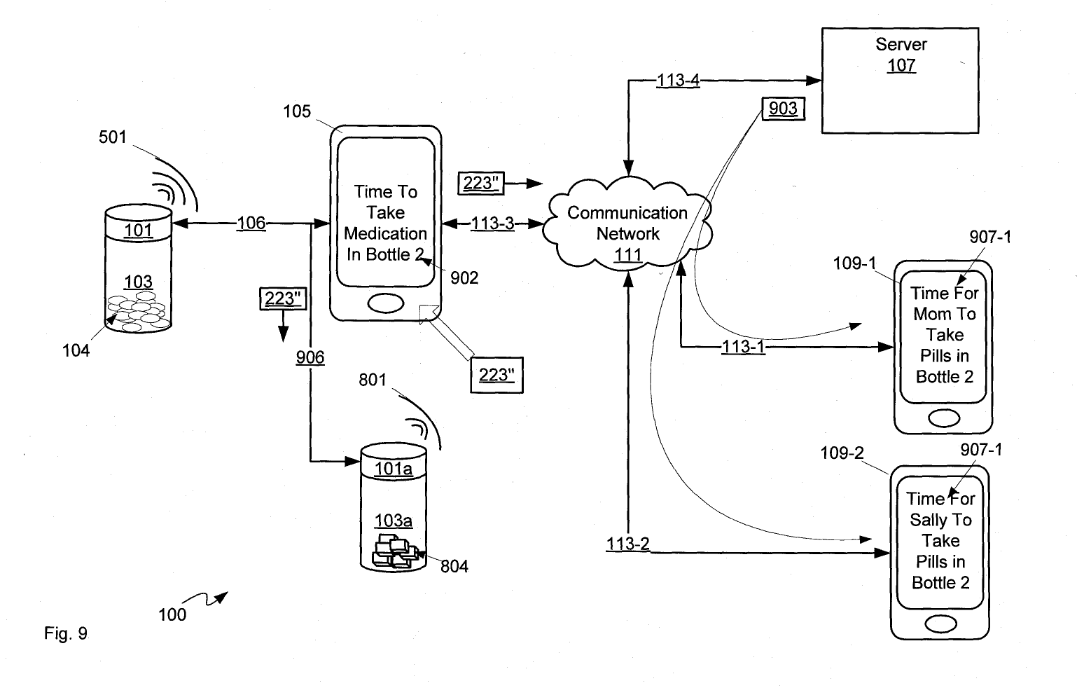

Attention is next directed to FIG. 9, in which system 100 has been adapted to include a second device 101a, similar to device 101, and a second dispenser 103a, similar to dispenser 103, device 101a in communication with device 105 via a link 906, similar to link 106. In contrast to FIG. 8, in FIG. 9, dispenser 103a stores medication 804 rather than dispenser 103. Furthermore, application 330 is adapted to communicate with two devices 101, 101a; for example, each of devices 101, 101a can be assigned an identifier, such as “Bottle 1” and “Bottle 2”, and a schedule can be associated with each. For example, schedule 223 can be associated with device 101 and is otherwise as described above, and schedule 223″ can be associated with device 101a, schedule 223″ received at device 105 in a manner similar to schedule 223, schedule 223″ comprising times at which medication 804 is to be taken. Alerts 501, 801 can be provided at respective devices 101, 101a at times that respective medication 104, 804 are to be taken, and alerts 902, 907-1, 907-2 can be provided at respective devices 105, 109 indicating from which dispenser 103, 103a medication is to be used. It is assumed in FIG. 9 that medication 804 is to be taken from dispenser 103a, and that “Bottle 2” identifies device 101a and/or dispenser 103a. IT is further assumed in FIG. 9 that schedule 223″ is transmitted from device 105 to server 107, and server 107 transmits an alert 903 to one or more of devices 109 at times that medication 804 is to be taken.

Hence, as depicted in FIG. 9, system 100 can be adapted for multi-dispenser support. While two devices 101, 101a are depicted in FIG. 9, in other implementations, system 100 can comprise more than two devices similar to devices 101, 101a and more than two dispensers. In other words, device 105 can be further configured to communicate with two or more devices, including devices 101, 101a, to provide respective dispensing schedules 223, 223″ to each of the two or more devices, and provide respective alerts 501, 8-1 according to each of the respective dispensing schedules 223, 223″.

Schedule 223 (and/or schedules 223′, 223″) can be adapted for complexity. For example, while some medications have simple schedules with a basic periodicity (e.g. one pill a day after or before an evening meal), other medications can have more complex schedules (e.g. 1 pill in the morning, 2 in the evening, 3 before bed); as such, schedule 223 is not limited to simple periodicity, but can include any dispensing schedule of any complexity that can be stored at memory 222, alerts being provide at device 101 according to the dispensing schedule.

In yet further implementations one or more of device 101 and device 105 can be adapted with lost and found capabilities. For example, one or more of devices 101, 105 can be further configured to provide an alert notification when device 101 and device 105 lose communication with each other. For example, such an alert can be provided as a separation alert to provide an indication that devices 101, 105 have been separated. Such a separation alert can be provided as a reminder to take dispenser 103 along when leaving a location where dispenser 103 is located.

Alternatively, when device 101 and/or dispenser 103 has been misplaced, device 105 can transmit a signal to device 101 to emit an audible and/or visual alert so that device 101 and/or dispenser 103 can be located by a user. When device 101 is both misplaced and out of range of device 105, so that link 106 is lost and/or not established, device 105 can be moved around a location until link 106 is established so that the signal transmitted by device 105 can be received at device 101, and the audible and/or visual alert emitted. In some of these implementations, the audible and/or visual alert provided during a lost and found scenario can be different than an alert provided at a time medication 104 is to be taken.

In yet further implementations, device 105 can be configured to provide alerts when an opening (and/or closing) event is sensed by sensor 227 off of schedule 223. For example, such an opening (and/or closing) event that is off of schedule 223 can be indicative of dispenser 103 being opened without consent of a user of devices 101, 105. Such an alert can be provided when the off-schedule opening (and/or closing) event occurs and/or when link 106 is established and sensor data 229 is received at device 105.

It is further appreciated that data associated with application 330 can be stored at server 107, as described above with respect to FIGS. 4, 5 and 7. As such, when a user of device 101 changes communication devices (e.g. discards device 105) a new communication device (similar to device 105) can be provisioned with application 330 and application data can be synchronized with the new communication device. Hence, when a new communication device, smartphone and the like, is provided in system 100, in place of device 105, settings for device 101 and/or application 330 can be restored within system 100 at the new communication device when the new communication device registers with server 107 using credentials associated with application 330 and the like.

In particular non-limiting implementations device 101 can be further configured to mate with, and seal, conventional off-the-shelf pill bottles and/or different types of devices 101 can be provided that mate with, and seal, different types of off-the-shelf pill bottles. Hence, device 101 can be fitted onto a pill bottle received from a pharmacy, the conventional lid removed from the pill bottle and replaced with device 101.

In some implementations, device 101 can be configured to fit in a pocket of user. In other words, housing 209 can be cylindrical with a longitudinal length of between about 1 to about 3 cm, and a diameter similar to a pill bottle with which housing 209 mates; furthermore, components of device 101 can be chosen to fit inside housing 209. For example, a PCB (printed circuit board) can be adapted to have a shape that fits inside housing 209. In particular, as device 101 can comprise a short range wireless communication interface, rather than a long range wireless communication interface, and as short range wireless communication interfaces can be more compact than long range wireless communication interfaces, device 101 can be made to fit comfortably in the pocket of a user, with device 105 providing the long range network connectivity associated with device 101. Indeed, from this perspective, device 105 acts as an intermediary between device 101 and server 107 (and/or devices 109).

Persons skilled in the art will appreciate that there are yet more alternative implementations and modifications possible.

For example, in some implementations, device 105 can comprise a camera and alerts at device 105 can comprise an image of medication 104 and/or dispenser 103 captured with the camera.

In yet further implementations, schedule 223 can include a name of medication 104 and device 105 can be configured to automatically download information associated with the name and one or more of provide the information in the alerts and/or incorporate the information into schedule 223. For example, when the information indicates that food is to be taken within a given time period before taking medication 104, schedule 223 can be automatically adapted to provide an alert to take food according to the downloaded information.

In yet further implementations, device 101 can be adapted with GPS (global positioning system) capabilities so that device 101 can be tracked using GPS and/or on-line mapping applications, and the like.

In yet further implementations, device 101 can comprise an emergency button, and the like, that, when actuated, causes a message to be transmitted to one or more devices 109 as an emergency alert.

In yet further implementations, device 101 can be unlocked via transmission of a signal from device 105 to device 101, as a childproofing feature, though device 101 can comprise a mechanical emergency unlock device that can be used when connectivity between devices 101, 105 is lost.

Those skilled in the art will appreciate that in some implementations, the functionality of devices 101, 105, 109 and server 107 can be implemented using pre-programmed hardware or firmware elements (e.g., application specific integrated circuits (ASICs), electrically erasable programmable read-only memories (EEPROMs), etc.), or other related components. In other implementations, the functionality of devices 101, 105, 109 and server 107 can be achieved using a computing apparatus that has access to a code memory (not shown) which stores computer-readable program code for operation of the computing apparatus. The computer-readable program code could be stored on a computer readable storage medium which is fixed, tangible and readable directly by these components, (e.g., removable diskette, CD-ROM, ROM, fixed disk, USB drive, flash drive, SD card, mini-SD card, and the like). Furthermore, it is appreciated that the computer-readable program can be stored as a computer program product comprising a computer usable medium. Further, a persistent storage device can comprise the computer readable program code. It is yet further appreciated that the computer-readable program code and/or computer usable medium can comprise a non-transitory computer-readable program code and/or non-transitory computer usable medium. Alternatively, the computer-readable program code could be stored remotely but transmittable to these components via a modem or other interface device connected to a network (including, without limitation, the Internet) over a transmission medium. The transmission medium can be either a non-mobile medium (e.g., optical and/or digital and/or analog communications lines) or a mobile medium (e.g., microwave, infrared, free-space optical or other transmission schemes) or a combination thereof.

Persons skilled in the art will appreciate that there are yet more alternative implementations and modifications possible, and that the above examples are only illustrations of one or more implementations. The scope, therefore, is only to be limited by the claims appended hereto.

What is claimed is:

1. A system comprising:
a device comprising: a sensor configured to detect opening and closing of a dispenser; a memory storing a dispensing schedule; an alert device configured to provide alerts; a short range wireless communication interface; and a processor configured to: control the alert device to provide alerts according to the dispensing schedule; and communicate sensor data using the short range wireless communication interface; and,
a communication device comprising a respective processor, a respective memory storing a dispensing application, a respective short range wireless communication interface; and a long range communication interface, the respective processor configured to: receive the dispensing schedule using the dispensing application; and transmit the dispensing schedule to the device using the respective short range wireless communication interface and the dispensing application, and transmit data associated with the dispensing application using the long range communication interface, the data comprising one or more of the dispensing schedule and the sensor data.

2. The system of claim 1, further comprising a server configured to: communicate with the communication device using the long range communications interface to receive and store the data associated with the dispensing application received from the communication device.

3. The system of claim 2, wherein the server is further configured to transmit respective alerts to one or more remote computing devices according to one or more of the dispensing schedule and when the sensor data indicates that the opening and the closing of the dispenser is not occurring according to the dispensing schedule.

4. The system of claim 2, wherein the server is further configured to transmit the data associated with the dispensing application to one or more remote computing devices so that the one or more remote computing devices can provide respective alerts according to one or more of the dispensing schedule and when the sensor data indicates that the opening and the closing of the dispenser is not occurring according to the dispensing schedule.

5. The system of claim 2, wherein the server is further configured to transmit the associated with the dispensing application to a new communication device storing a respective dispensing application, the new communication device configured to communicate with the device.

6. The system of claim 1, further comprising one or more remote computing devices, each comprising a respective application configured to provide respective alerts according to one or more of the dispensing schedule and when the sensor data indicates that the opening and the closing of the dispenser is not occurring according to the dispensing schedule.

7. The system of claim 6, wherein the respective alerts provided by the respective application at each of the one or more remote computing devices is customizable using the respective application.

8. The system of claim 1, wherein the processor is further configured to transmit one or more of firmware updates and software updates to the device using the respective short range wireless interface.

9. The system of claim 1, wherein the dispensing schedule comprises one or more times that items stored at the dispenser are to be dispensed and one or more further times that one or more of food and drink are to be ingested, one or more of the device and the dispensing application further configured to provide respective alerts according to the one or more times and the one or more further times.

10. The system of claim 1, wherein one or more the device and the dispensing application are further configured to provide an alert when the device and the communication device lose communication with each other.

11. The system of claim 1, wherein the communication device is further configured to communicate with two or more devices, including the device, to provide respective dispensing schedules to each of the two or more devices, and provide respective alerts according to each of the respective dispensing schedules.

12. The system of claim 1, wherein the device is further configured to provide the alerts in an absence of connectivity between the device and the communication device, and after the dispensing schedule is received at the device.
